(19) United States
(12) Patent Application Publication
(10) Pub. No.: US 2023/0153915 A1
(43) Pub. Date: May 18, 2023

(54) INFORMATION PROCESSING DEVICE, INSURANCE PREMIUM DETERMINING METHOD, AND SYSTEM

(71) Applicant: PANASONIC INTELLECTUAL PROPERTY MANAGEMENT CO., LTD., Osaka (JP)

(72) Inventors: Takuma IIDA, KANAGAWA KEN (JP); Masaaki HOSHIDA, OSAKA FU (JP); Kohsuke YAMAGUCHI, KANAGAWA KEN (JP)

(73) Assignee: PANASONIC INTELLECTUAL PROPERTY MANAGEMENT CO., LTD., Osaka (JP)

(21) Appl. No.: 18/098,502

(22) Filed: Jan. 18, 2023

Related U.S. Application Data
(63) Continuation of application No. PCT/JP2021/018289, filed on May 13, 2021.

(30) Foreign Application Priority Data
Jul. 22, 2020 (JP) 2020-125767

(51) Int. Cl. G06Q 40/08

(52) U.S. Cl. CPC G06Q 40/08

(57) ABSTRACT

An information processing device according to the present disclosure includes one or more hardware processors configured to function as a risk calculation unit configured to calculate a degree of risk indicating a risk of ignition of a battery as an index based on information concerning an ignition factor of the battery mounted on a vehicle, and an insurance premium determination unit configured to determine an insurance premium in accordance with the degree of risk.

### CROSS-REFERENCE TO RELATED APPLICATIONS

This application is a continuation of International Application No. PCT/JP2021/018289, filed on May 13, 2021, which is based on the Japanese Patent Application No. 2020-125767, filed on Jul. 22, 2020, the entire contents of which are incorporated herein by reference.

### FIELD

The present disclosure relates to an information processing device, an insurance premium determining method, and a system.

### BACKGROUND

Electric motor vehicles such as an electric vehicle have a risk of a vehicle fire caused by a battery. Such a vehicle fire may be caused when the battery is used under a load, or caused by a manufacturing defect or the like.

### BRIEF DESCRIPTION OF THE DRAWINGS

FIG. 1 is an entire view illustrating an example of a configuration of an insurance premium determining system according to a first embodiment;

FIG. 2 is a diagram illustrating an example of configurations of a BMU, CMU, and a battery according to the first embodiment;

FIG. 3 is a block diagram illustrating an example of a functional configuration of the BMU according to the first embodiment;

FIG. 4 is a block diagram illustrating an example of a functional configuration of a server device according to the first embodiment;

FIG. 5 is a flowchart illustrating an example of a procedure of insurance premium determination processing performed by the server device according to the first embodiment;

FIG. 6 is an entire view illustrating an example of a configuration of an insurance premium determining system according to a second embodiment;

FIG. 7 is a block diagram illustrating an example of a functional configuration of a server device according to the second embodiment; and

FIG. 8 is a flowchart illustrating an example of a procedure of insurance premium determination processing performed by the server device according to the second embodiment.

### DETAILED DESCRIPTION

An information processing device according to the present disclosure includes one or more hardware processors configured to function as a risk calculation unit and an insurance premium determination unit. The risk calculation unit is configured to calculate a degree of risk indicating a risk of ignition of a battery as an index based on information concerning an ignition factor of the battery mounted on a vehicle. The insurance premium determination unit is configured to determine an insurance premium in accordance with the degree of risk. Herein, it is an object of the present disclosure to provide an information processing device, an insurance premium determining method, and a system that can appropriately set an insurance premium in accordance with a state of a battery.

The following describes embodiments of an information processing device, an insurance premium determining method, and a system according to the present disclosure with reference to the drawings.

### First Embodiment

The following describes a first embodiment with reference to the drawings.

Configuration example of insurance premium determining system

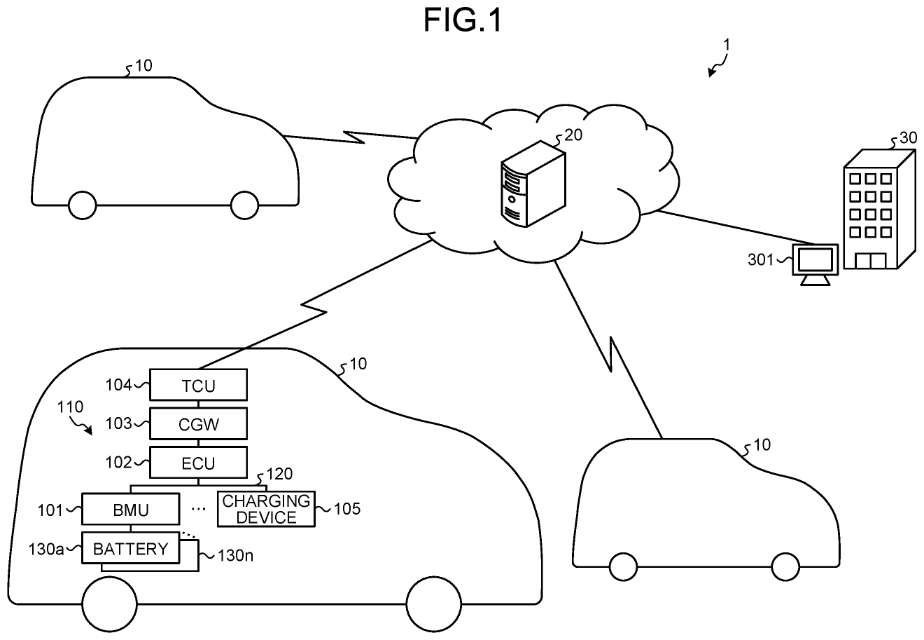

FIG. 1 is an entire view illustrating an example of a configuration of an insurance premium determining system 1 according to the first embodiment. As illustrated in FIG. 1, the insurance premium determining system 1 includes a vehicle control system 110 mounted on a vehicle 10, a server device 20 placed on a cloud, and an information terminal 301 of an insurance company 30.

Each of a plurality of the vehicles 10 is a vehicle covered by vehicle insurance and the like contracted, for example, the vehicle owned by an insured person taking out the insurance of the insurance company 30. The insurance company 30 sets an insurance premium for each of the vehicles 10. Each of the vehicles 10 is equipped with the vehicle control system 110 connected to the server device 20 via a network.

The vehicle 10 is an electric vehicle (EV) that is driven by using electric power of a battery 130. However, the vehicle 10 may be a hybrid vehicle (HV) using power of an internal combustion engine and the like in addition to the electric power of the battery 130.

The vehicle control system 110 includes a Telematics Control Unit (TCU) 104, a Central Gateway (CGW) 103, an electronic control unit (ECU) 102, a battery management unit (BMU) 101, a plurality of batteries 130a to 130n, and a charging device 105.

These configurations are connected via an in-vehicle network 120. The in-vehicle network 120 is, for example, a controller area network (CAN). Within the vehicle control system 110, all of the configurations may be connected to the one in-vehicle network 120, or may be connected to a plurality of channels of the in-vehicle network in a divided manner.

Each of the batteries 130a to 130n supplies electric power for driving the vehicle 10. In the present specification, in a case of not distinguishing the batteries 130a to 130n from each other, each of the batteries 130a to 130n may be simply referred to as the battery 130. The only one battery 130 may be used. The battery 130 is a rechargeable secondary battery, for example, a lithium ion battery. However, a type of the battery 130 is not particularly limited, and may be a nickel hydrogen battery and the like, for example.

The charging device 105 charges the battery 130 with electric power supplied, for example, from the outside of the vehicle 10 or regenerative electric power.

The BMU 101 as an information generation unit collects various kinds of data indicating a state of the battery 130, analyzes the state of the battery 130 based on the acquired various kinds of data, and transmits an analysis result to the ECU 102 via the in-vehicle network 120. The BMU 101 is also called a battery management system (BMS).

The battery information collected by the BMU 101 includes various measured values such as a voltage, a current, a temperature, and an internal resistance of the battery 130. The BMU 101 computes a deterioration state of the battery (State Of Health: SOH), a charging state thereof (State Of Charge: SOC), and the like from the various measured values, and estimates a state of an ignition factor such as an amount of the ignition factor in the battery 130.

The SOH is a percentage of a ratio of a current full charge capacity (Ah) to an initial full charge capacity (Ah). As a value of the SOH is closer to 100%, a degree of deterioration is lower. The SOC is a percentage of a ratio of a residual capacity (Ah) to the full charge capacity (Ah). An ideal use state of the battery 130 is to be used with the value of the SOC close to 50% as a median.

As the ignition factor in the battery 130, for example, a minute short circuiting is exemplified, and in a case in which the battery 130 is a lithium ion battery, lithium precipitation and the like are exemplified. As described later, in a case in which a lithium precipitation amount and a minute short-circuiting amount are large, the battery 130 may generate heat, and may cause ignition in the worst case.

The BMU 101 not only performs computation and estimation by collecting the information from the battery 130, but may also collect the information concerning the battery from the outside to compute or estimate the information concerning the battery based on the information collected from the outside.

The ECU 102 is a vehicle control unit (VCU) that controls the entire vehicle 10. The ECU 102 transmits the battery information such as the SOH, the SOC, and the ignition factor acquired from the BMU 101 to the server device 20 via the CGW 103 and the TCU 104.

The TCU 104 has a function of executing wireless communication with an external device, and executes wireless communication with the server device 20, for example. The CGW 103 relays data communication between the ECU 102 and the outside.

The server device 20 as an information processing device is owned by a service provider that provides a service of calculating an insurance premium to the insurance company 30, for example. The server device 20 may be constituted of one server device, for example, or may be constituted of a plurality of server devices connected to the Internet.

The server device 20 has a function of receiving the battery information concerning the battery 130 transmitted from each of the vehicles 10, and determining an insurance premium set for each of the vehicles 10 based on the information. The server device 20 also transmits information on the determined insurance premium to the information terminal 301 of the insurance company 30.

The insurance company 30 receives the service of calculating the insurance premium from the service provider. The information terminal 301 is a personal computer (PC) installed in the insurance company 30, a tablet terminal, or the like. The information terminal 301 is connected to the server device 20 in a wireless manner or a wired manner, and receives, from the server device 20, the information on the insurance premium determined by the server device 20.

Configuration Example of Battery

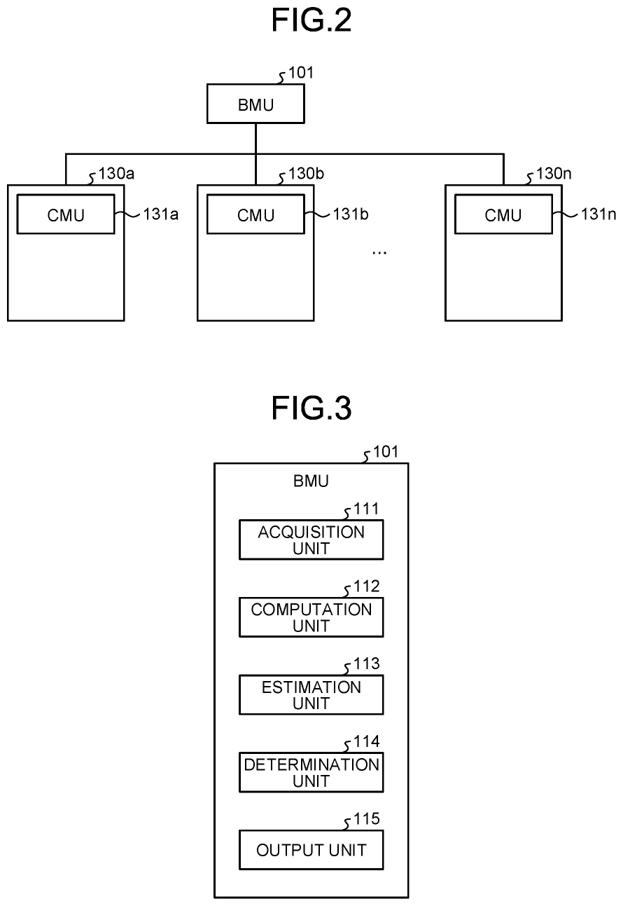

FIG. 2 is a diagram illustrating an example of configurations of the BMU 101, CMUs 131a to 131n, and the batteries 130a to 130n according to the first embodiment.

As illustrated in FIG. 2, the cell monitoring units (CMUs) 131a to 131n are disposed corresponding to the batteries 130a to 130n on a one-to-one basis. In the present specification, in a case of not distinguishing the CMUs 131a to 131n from each other, each of the CMUs 131a to 131n may be simply referred to as a CMU 131.

The CMU 131 includes various sensors such as a current sensor, a voltage sensor, and a temperature sensor for measuring the state of the battery 130. Alternatively, these sensors may be disposed outside the CMU 131, and the CMU 131 may acquire measured values from these sensors.

The batteries 130 are connected in parallel, for example. The BMU 101 acquires the various kinds of data described above from each of the batteries 130 connected in parallel.

Functional Configuration Example of BMU

FIG. 3 is a block diagram illustrating an example of a functional configuration of the BMU 101 according to the first embodiment. As illustrated in FIG. 3, the BMU 101 includes an acquisition unit 111, a computation unit 112, an estimation unit 113, a determination unit 114, and an output unit 115.

The acquisition unit 111, the computation unit 112, the estimation unit 113, the determination unit 114, and the output unit 115 are stored and provided in a memory of the BMU 101 as a computer-executable computer program. A processor of the BMU 101 implements a function corresponding to each of the units described above by reading out, from the memory, and executing the computer program.

The computer program executed by the BMU 101 may be recorded and provided in a computer-readable recording medium such as a CD-ROM, a flexible disk (FD), a CD-R, and a digital versatile disc (DVD) as an installable or executable file.

The computer program executed by the BMU 101 may be stored in a computer connected to a network such as the Internet, and provided by being downloaded via the network. The computer program executed by the BMU 101 may be executed via a network such as the Internet without being downloaded by the BMU 101 to be installed therein.

Alternatively, part or all of the functions of the acquisition unit 111, the computation unit 112, the estimation unit 113, the determination unit 114, and the output unit 115 may be implemented by a dedicated hardware circuit.

The acquisition unit 111 acquires measured values such as a voltage, a current, and a temperature of the battery 130 from the CMU 131 based on a given collecting condition. The collecting condition is determined by the determination unit 114, for example, and includes a collection period for collecting data, a type of data to be collected, and the like. The acquisition unit 111 sends out the acquired measured values to the computation unit 112, the estimation unit 113, and the output unit 115.

The computation unit 112 calculates a computed value representing a characteristic of the battery 130 based on the measured value acquired by the acquisition unit 111. By way of example, the computation unit 112 calculates the SOH and the SOC of each of the batteries 130. The computation unit 112 sends out the calculated SOH and SOC to the determination unit 114 and the output unit 115.

The estimation unit 113 estimates the lithium precipitation amount and the minute short-circuiting amount, which are ignition factors of the battery 130, based on the measured values acquired by the acquisition unit 111.

In a case in which the battery 130 is a lithium ion battery, precipitation of lithium metal proceeds inside the battery 130 while charge and discharge are repeatedly performed. When the lithium precipitation amount inside the battery 130 is increased, precipitated lithium may break through a separator of the battery 130, and an internal short circuiting may be caused in some cases. The battery 130 generates heat due to the internal short circuiting, and may cause ignition in the worst case.

The estimation unit 113 collects voltage variation and current variation of the battery 130 during charge and discharge, and obtains a charge/discharge curve representing a relation between a voltage and capacity using an open circuit voltage (OCV) estimating method. The estimation unit 113 also estimates the lithium precipitation amount in the battery 130 by dQ/dV analysis for obtaining a dQ/dV curve by differentiating a voltage (V) at this point by an electric discharge capacity (Q).

In estimating the lithium precipitation amount, it is preferable to use data of the collected voltage variation and current variation at the time when the SOC falls within a given range of about 5%, for example. This is because capacity variation of the battery 130 can be more easily reflected in the voltage in a case in which the SOC is about 5% as compared with a case in which the SOC is about 50%, for example.

It is also preferable to use data of voltage variation and current variation that are collected during charge at the time when charge is performed while keeping a constant charging current. Additionally, it is also preferable to use data of voltage variation and current variation that are collected during discharge at the time when a discharging current is constant.

In this way, by using data that is collected from the battery 130 at the time when the SOC falls within a given range and a charging/discharging current is constant, more accurate estimation can be performed.

By regularly or irregularly acquiring the data described above multiple times and repeating estimation of the lithium precipitation amount, successive variation of the lithium precipitation amount can be obtained, and the state of the battery 130 can be determined more precisely.

On the other hand, a foreign substance such as a metal piece may be mixed in the battery 130 at a manufacturing step. Such a metal piece may cause a minute short circuiting inside the battery 130. If the metal piece breaks through the separator of the battery 130, similarly to the above description, the battery 130 may be ignited.

The estimation unit 113 collects the voltage variation of the battery 130 at the time when a load is not applied to the battery 130, that is, when the battery 130 is not being charged or discharged, and estimates the minute short-circuiting amount in the battery 130 based on the collected voltage variation. When a minute short circuiting occurs in the battery 130, a voltage drop is found in the battery 130 in a left state. The minute short-circuiting amount can be estimated from magnitude of the voltage drop. The minute short-circuiting amount may include a short circuiting caused by precipitated lithium in addition to a short circuiting caused by a foreign substance such as a metal piece.

In estimating the minute short-circuiting amount, it is preferable to use data of the collected voltage variation at the time when the SOC falls within a given range of about 5%, for example. The voltage variation is influenced by the temperature of the battery 130, so that it is preferable to use data that is collected when the temperature of the battery 130 is equal to or lower than a given temperature.

In this way, by using data that is collected from the battery 130 at the time when the SOC falls within the given range and the temperature is equal to or lower than the given temperature, more accurate estimation can be performed.

By regularly or irregularly acquiring the data described above multiple times and repeating estimation of the minute short-circuiting amount, successive variation of the minute short-circuiting amount can be obtained, and the state of the battery 130 can be determined more precisely.

The determination unit 114 sets the collecting condition in accordance with the deterioration state of the battery 130. By way of example, the determination unit 114 determines the deterioration state of the battery 130 based on at least one of the value of the SOH computed by the computation unit 112, an estimated value of the lithium precipitation amount estimated by the estimation unit 113, and an estimated value of the minute short-circuiting amount, and sets the collecting condition in accordance with the deterioration state.

At this point, the determination unit 114 may determine presence or absence of deterioration based on an average value or a median of SOHs, lithium precipitation amounts, or minute short-circuiting amounts of a plurality of the batteries 130, or may determine presence or absence of deterioration based on the worst value of the SOHs, the lithium precipitation amounts, or the minute short-circuiting amounts of the batteries 130.

The determination unit 114 determines the deterioration state of the battery 130 based on these values, and makes setting so that, as deterioration progresses, the collection period defined in the collecting condition is shortened, and the data is collected at a higher frequency. The determination unit 114 may also make setting so that, as deterioration progresses, the number of types of data defined in the collecting condition is increased.

Content of the latest collecting condition is saved in the memory of the BMU 101, for example, by the determination unit 114. The acquisition unit 111, the computation unit 112, and the estimation unit 113 read out the latest collecting condition from the memory, and performs processing in accordance with the read-out collecting condition.

The output unit 115 outputs the battery information that is acquired, computed, and estimated by the acquisition unit 111, the computation unit 112, and the estimation unit 113 to the ECU 102 via the in-vehicle network 120.

The ECU 102 transmits the battery information acquired from the BMU 101 to the server device 20 via the TCU 104 and the CGW 103. The battery information is transmitted to the server device 20, where the battery information is added with a vehicle ID or the like with which the battery-information-generated vehicle 10 is uniquely identifiable.

Functional Configuration Example of Server Device

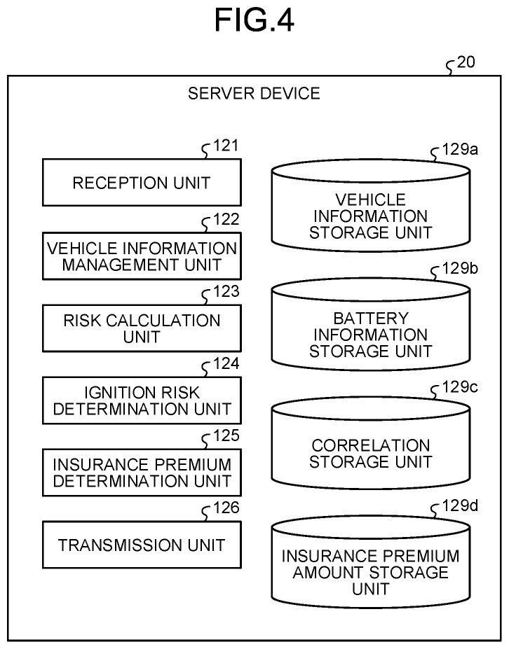

FIG. 4 is a block diagram illustrating an example of a functional configuration of the server device 20 according to the first embodiment. As illustrated in FIG. 4, the server device 20 includes a reception unit 121, a vehicle information management unit 122, a risk calculation unit 123, an ignition risk determination unit 124, an insurance premium determination unit 125, a transmission unit 126, a vehicle information storage unit 129a, a battery information storage unit 129b, a correlation storage unit 129c, and an insurance premium amount storage unit 129d.

The server device 20 is a computer including a microcontroller, for example. The microcontroller includes a processor, a random access memory (RAM), a read only memory (ROM), and the like. The microcontroller constituting the server device 20 may include an input/output circuit, a storage device, and the like. The processor reads out and executes a computer program stored in the ROM and the like to implement a function corresponding to each of the units described above.

The computer program executed by the server device 20 may be recorded and provided in a computer-readable recording medium such as a CD-ROM, a flexible disk, a CD-R, and a DVD as an installable or executable file.

The computer program executed by the server device 20 may be stored in a computer connected to a network such as the Internet, and provided by being downloaded via the network. The computer program executed by the server device 20 may be executed via a network such as the Internet without being downloaded by the server device 20 to be installed therein.

Alternatively, part or all of the functions of the reception unit 121, the vehicle information management unit 122, the risk calculation unit 123, the ignition risk determination unit 124, the insurance premium determination unit 125, the transmission unit 126, the vehicle information storage unit 129a, the battery information storage unit 129b, the correlation storage unit 129c, and the insurance premium amount storage unit 129d may be implemented by a dedicated hardware circuit.

The reception unit 121 receives the battery information concerning the battery 130 that is collected by the BMU 101 of the vehicle control system 110 mounted on the vehicle 10 and transmitted from the ECU 102 via the TCU 104 and the CGW 103. The reception unit 121 stores the received battery information in the battery information storage unit 129b.

The battery information storage unit 129b stores the battery information, which is transmitted from each of the vehicles 10 owned by an insured person as a customer of the insurance company 30, associated with the vehicle ID.

The vehicle information management unit 122 manages vehicle information stored in the vehicle information storage unit 129a. The vehicle information is generated by the information terminal 301 and the like of the insurance company 30, for example, for each of the vehicles 10 owned by the insured person as a customer of the insurance company 30, and transmitted to the server device 20 after the vehicle ID is added thereto. The vehicle information management unit 122 stores the transmitted vehicle information in the vehicle information storage unit 129a to be managed.

At a timing when the insurance premium determination unit 125 determines the insurance premium, the vehicle information management unit 122 acquires a piece of the vehicle information matching the vehicle ID of the vehicle 10 for which the insurance premium is to be set from a plurality of pieces of the vehicle information stored in the vehicle information storage unit 129a. The vehicle information includes information concerning the vehicle 10 such as a vehicle type, a year, a lot number and a type of the battery 130 mounted on the vehicle, and an insurance premium amount, a type, a class, a discount service, and the like of insurance currently applied to the vehicle.

The risk calculation unit 123 acquires, from the battery information storage unit 129b, the battery information matching the vehicle ID of the vehicle 10 for which the insurance premium is to be set. The risk calculation unit 123 calculates a degree of risk based on numerical values related to the ignition factor such as the lithium precipitation amount and the minute short-circuiting amount included in the acquired battery information.

The degree of risk indicates a risk leading to a vehicle fire as an index based on the numerical value related to the ignition factor such as the lithium precipitation amount and the minute short-circuiting amount, and is defined to have a favorable correlation with a possibility of ignition of the battery 130. To indicate the numerical value related to the ignition factor as an index, it is possible to use various methods such as using a statistical method or using a simulation value.

The risk calculation unit 123 may use different methods for calculating the degree of risk depending on a vehicle type, a year, and the like included in the vehicle information acquired by the vehicle information management unit 122.

The ignition risk determination unit 124 estimates the possibility that the battery 130 is ignited by applying the degree of risk calculated by the risk calculation unit 123 to a correlation between the degree of risk and the possibility that the battery 130 is ignited stored in the correlation storage unit 129c. The ignition risk determination unit 124 also determines an ignition risk of the battery 130 in the vehicle 10 based on an estimation result of the possibility of ignition.

The correlation storage unit 129c may store a plurality of correlations corresponding to a vehicle type, a year, and the like, and the ignition risk determination unit 124 may determine the ignition risk by using the correlation corresponding to a vehicle type, a year, and the like included in the vehicle information acquired by the vehicle information management unit 122.

The insurance premium determination unit 125 refers to an insurance premium amount table stored in the insurance premium amount storage unit 129d, and determines the insurance premium set for the vehicle 10 based on a determination result of the ignition risk determination unit 124 while taking into account a class and the like of the insured person who owns the vehicle 10. The class of the insured person may be set based on an accident history, an offense history, and the like of the insured person as usual.

The insurance premium amount storage unit 129d stores a plurality of insurance premium amount tables corresponding to a vehicle type, a year, and the like. In each of the insurance premium amount tables, the insurance premium amount corresponding to the class of the insured person and the ignition risk of the vehicle 10 is set.

As the timing at which the insurance premium is determined by the server device 20 as described above, for example, exemplified are a timing of a new contract, a timing given number of days before or given number of months before an update date, and the like based on the update date.

The transmission unit 126 adds the vehicle ID to the information on the insurance premium determined by the insurance premium determination unit 125, and transmits the information to the information terminal 301 of the insurance company 30. Due to this, the insurance company 30 can receive a service of providing the insurance premium that should be set for the vehicle 10 of the insured person corresponding to the vehicle ID.

The following describes some examples in which the insurance premium is determined by the server device 20.

In a case in which the vehicle 10 for which the insurance premium is to be set is a new car, numerical values related to the ignition factor such as the lithium precipitation amount and the minute short-circuiting amount are not so largely different between the same vehicle types. Thus, the server device 20 determines the insurance premium merely based on the vehicle type, the class of the insured person, and the like for a new car. Thereafter, as the year of the vehicle 10 gets older, the state of the battery 130 is reflected in the insurance premium.

On the other hand, in a case in which the insured person purchases a used car as the vehicle 10 for which the insurance premium is to be set, the numerical values related to the ignition factor such as the lithium precipitation amount and the minute short-circuiting amount may be different even between the same vehicle types due to a use history and the like of the used car at that point. Due to this, the insured person who purchased the used car the numerical values of which are bad appears to be disadvantageous because a high insurance premium is set therefor.

However, in a case in which the insured person makes efforts at driving and using the battery 130 not to damage the battery 130, a price-rise rate of the insurance premium at the time of update is suppressed to be low. Thus, in the long term, the insured person can get an advantage corresponding to such efforts.

Example of Insurance Premium Determination Processing Performed by Server Device

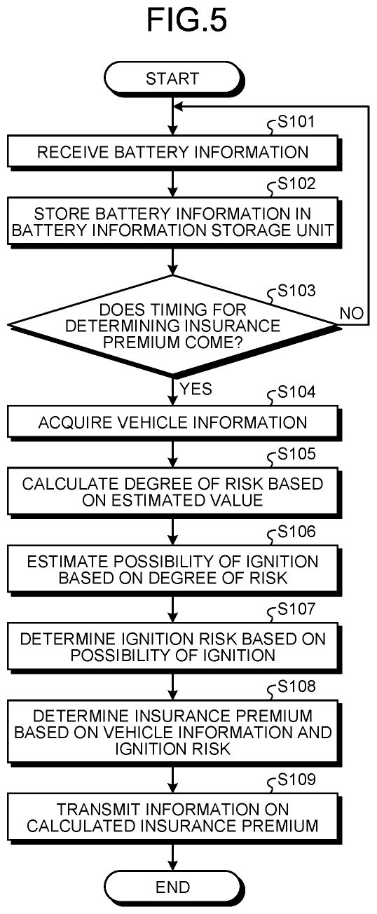

FIG. 5 is a flowchart illustrating an example of a procedure of insurance premium determination processing performed by the server device 20 according to the first embodiment. In starting the processing illustrated in FIG. 5, it is assumed that the server device 20 has already acquired the vehicle information such as a vehicle type, a year, and an insurance premium amount, a type, a class, a discount service, and the like of insurance currently applied to the vehicle for the insured person as a customer of the insurance company 30, and has already stored the acquired vehicle information in the vehicle information storage unit 129a.

As illustrated in FIG. 5, the reception unit 121 of the server device 20 receives the battery information generated by the BMU 101 from the vehicle control system 110 of the specific vehicle 10 (Step S101). The reception unit 121 stores the received battery information in the battery information storage unit 129b (Step S102). The reception unit 121 continues the processing at Steps S101 and S102 until a timing when the insurance premium determination unit 125 determines the insurance premium (Step S103).

When the timing at which the insurance premium determination unit 125 determines the insurance premium comes (Yes at Step S103), the vehicle information management unit 122 acquires, from the vehicle information storage unit 129a, the vehicle information concerning the vehicle 10 for which the insurance premium is determined (Step S104).

The risk calculation unit 123 acquires the battery information on the vehicle 10 for which the insurance premium is determined from the battery information storage unit 129b, and calculates the degree of risk based on the estimated value of the lithium precipitation amount and the estimated value of the minute short-circuiting amount included in the acquired battery information (Step S105).

The ignition risk determination unit 124 applies the degree of risk calculated by the risk calculation unit 123 to the correlation stored in the correlation storage unit 129c, and estimates the possibility of ignition of the battery 130 mounted on the vehicle 10 (Step S106).

The ignition risk determination unit 124 also determines the ignition risk of the vehicle 10 based on the estimated possibility of ignition (Step S107).

The insurance premium determination unit 125 acquires, from the insurance premium amount storage unit 129d, the insurance premium amount table corresponding to a vehicle type and a year of the vehicle information acquired by the vehicle information management unit 122, and determines the insurance premium based on a class indicated by the vehicle information and a determination result obtained by the ignition risk determination unit 124 (Step S108).

The transmission unit 126 transmits information including the insurance premium determined by the insurance premium determination unit 125 to the information terminal 301 of the insurance company 30 (Step S109).

As described above, the insurance premium determination processing performed by the server device 20 according to the first embodiment ends.

Overview

In electric motor vehicles such as an electric vehicle, a vehicle fire is caused by a battery. A fire caused by the battery includes a fire caused by a manufacturing defect and the like in addition to a fire caused by a method of using the vehicle and the battery.

However, in a present insurance system, the insurance premium is determined to be a uniform premium in accordance with a vehicle equipped with an internal combustion engine using gasoline and the like, and the premium is not determined depending on the state of the battery. In this way, a mechanism of reflecting the risk of ignition of the battery in the insurance premium is not established, so that the insurance premium is not appropriately set in some cases.

The server device 20 according to the first embodiment calculates the degree of risk indicating the risk of ignition of the battery 130 as an index based on the information concerning the ignition factor of the battery 130 mounted on the vehicle 10, and determines the insurance premium in accordance with the degree of risk. Due to this, the insurance premium can be appropriately set in accordance with the state of the battery 130.

The server device 20 according to the first embodiment causes the information concerning the ignition factor to include the lithium precipitation amount in the battery 130, and acquires the lithium precipitation amount estimated from the voltage variation and the current variation in the battery 130 during charge and discharge. Due to this, the state of the battery 130 can be appropriately determined.

The server device 20 according to the first embodiment acquires the lithium precipitation amount that is estimated by using the voltage variation and the current variation at the time when the SOC of the battery 130 falls within the given range, the charging current is constant, and the discharging current is constant. Due to this, a highly accurate estimated value of the lithium precipitation amount can be used, and the state of the battery 130 can be more appropriately determined.

The server device 20 according to the first embodiment causes the information concerning the ignition factor to include the minute short-circuiting amount in the battery 130, and acquires the minute short-circuiting amount that is estimated from the voltage variation in the battery 130 when charge and discharge are not performed. Due to this, the state of the battery 130 can be appropriately determined.

The server device 20 according to the first embodiment acquires the minute short-circuiting amount that is estimated by using the voltage variation at the time when the SOC of the battery 130 falls within the given range and the temperature of the battery 130 is equal to or higher than the given temperature. Due to this, a highly accurate estimated value of the minute short-circuiting amount can be used, and the state of the battery 130 can be more appropriately determined.

The server device 20 according to the first embodiment determines the ignition risk of the battery 130 based on the correlation between the degree of risk and the possibility that the battery 130 is ignited, and determines the insurance premium based on the determination result of the ignition risk. In this way, the insurance premium is determined based on the degree of risk indicated as an index to have a high correlation with the possibility that the battery 130 is ignited, so that a procedure of determining the insurance premium can be more generalized, and the insurance premium can be appropriately determined.

The information on the insurance premium based on the function of the server device 20 according to the first embodiment described above may be provided to a used car dealer, a used car distribution market, and the like. Due to this, for example, by causing a used vehicle to have information on an insurance premium of the used vehicle to be marketed, value can be added thereto.

### Second Embodiment

The following describes a second embodiment with reference to the drawings. The server device according to the second embodiment is different from that in the first embodiment described above in that information related to handling of the battery by the insured person is reflected in the insurance premium.

Configuration Example of Insurance Premium Determining System

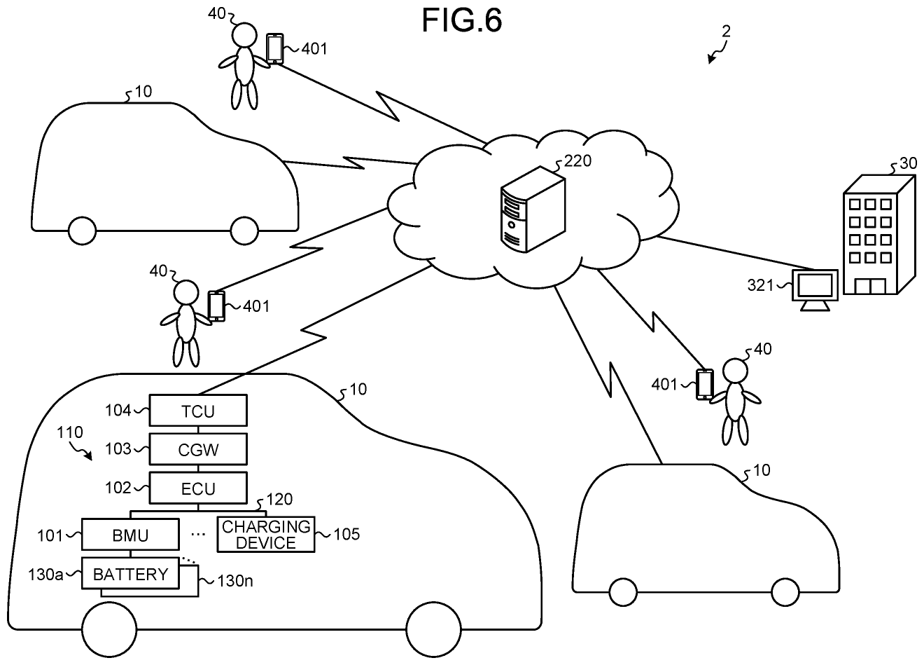

FIG. 6 is an entire view illustrating an example of a configuration of an insurance premium determining system 2 according to the second embodiment. As illustrated in FIG. 6, the insurance premium determining system 2 includes the vehicle control system 110 mounted on the vehicle 10, an information terminal 321 of the insurance company 30, an information terminal 401 of an insured person 40, and a server device 220 placed on a cloud.

The vehicle 10 and the vehicle control system 110 mounted on the vehicle 10 have the same configurations as those in the first embodiment described above. The vehicle control system 110 communicates with the server device 220 via a wireless or wired network.

The information terminal 401 of the insured person 40 is, for example, a smartphone, a cellular telephone, a tablet, a PC, and the like. The information terminal 401 is connected to the server device 220 via a wireless or wired network, and can access information on the battery 130 stored in the server device 220.

The server device 220 as an information processing device has a function of receiving the battery information concerning the battery 130 transmitted from each of the vehicles 10, and determining the insurance premium set for each of the vehicles 10 based on the information. At this point, the server device 220 also refers to information concerning handling of the battery 130 by the insured person 40. The server device 220 also transmits information on the determined insurance premium to the information terminal 321 of the insurance company 30.

The server device 220 also acquires information to be presented to a specific insured person 40, for example, from the information terminal 321 of the insurance company 30. The server device 220 also presents the acquired information to the insured person 40 as a presentation target.

The information terminal 321 possessed by the insurance company 30 is connected to the server device 220 in a wireless or wired manner, and receives, from the server device 220, the information on the insurance premium determined by the server device 220. The information terminal 321 also generates, for the specific insured person 40, information to be presented to the insured person 40, and transmits the information to the server device 220.

Functional Configuration Example of Server Device

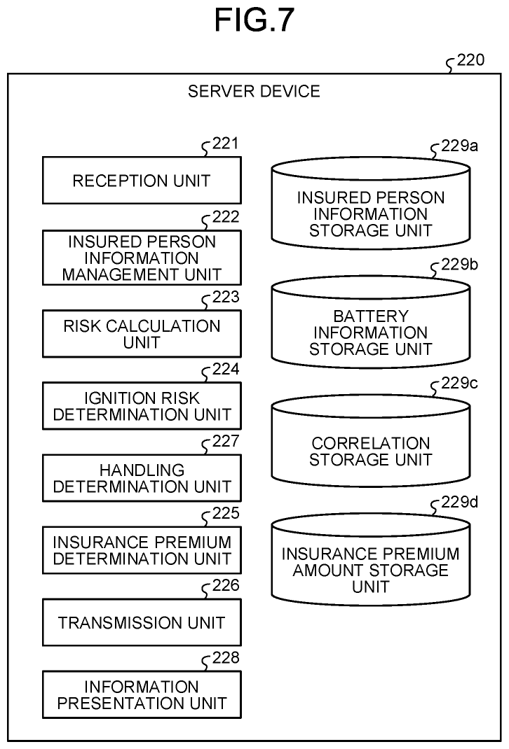

FIG. 7 is a block diagram illustrating an example of a functional configuration of the server device 220 according to the second embodiment. As illustrated in FIG. 7, the server device 220 includes a reception unit 221, an insured person information management unit 222, a risk calculation unit 223, an ignition risk determination unit 224, a handling determination unit 227, an insurance premium determination unit 225, a transmission unit 226, an information presentation unit 228, an insured person information storage unit 229a, a battery information storage unit 229b, a correlation storage unit 229c, and an insurance premium amount storage unit 229d.

The server device 220 is a computer including a microcontroller that includes a processor, a RAM, and a ROM, for example. The microcontroller may include an input/output circuit, a storage device, and the like. The processor reads out and executes a computer program stored in the ROM and the like to implement a function corresponding to each of the units described above.

The computer program executed by the server device 220 may be recorded and provided in a computer-readable recording medium such as a CD-ROM, a flexible disk, a CD-R, and a DVD as an installable or executable file.

The computer program executed by the server device 220 may be stored in a computer connected to a network such as the Internet, and downloaded or executed via the network.

Alternatively, part or all of the functions corresponding to the respective units described above may be implemented by a dedicated hardware circuit.

The reception unit 221 receives the battery information concerning the battery 130 that is collected by the BMU 101 of the vehicle control system 110 mounted on the vehicle 10 and transmitted from the ECU 102 via the TCU 104 and the CGW 103. The reception unit 221 stores the received battery information in the battery information storage unit 229b.

The reception unit 221 also receives the information to be presented to the specific insured person 40 from the information terminal 321 of the insurance company 30. The information terminal 321 of the insurance company 30 adds a driver ID, as identification information with which the insured person 40 is uniquely identifiable, to the information desired to be presented to the specific insured person 40, and transmits the information to the server device 220.

The insured person information management unit 222 manages insured person information stored in the insured person information storage unit 229a. The insured person information is generated by the information terminal 321 of the insurance company 30 and the like, for example, for each of insured persons 40 as a customer of the insurance company 30, and transmitted to the server device 220 after the driver ID is added thereto. The insured person information management unit 222 stores the transmitted insured person information in the insured person information storage unit 229a to be managed.

At the timing when the insurance premium determination unit 225 determines the insurance premium, the insured person information management unit 222 acquires a piece of the insured person information matching the driver ID and the like corresponding to the vehicle 10 for which the insurance premium is set from among a plurality of pieces of the insured person information stored in the insured person information storage unit 229a.

The insured person information includes information concerning the vehicle 10 such as a vehicle type and a year of the vehicle 10 for which the insurance premium is set and vehicle insurance or the like is contracted, the vehicle 10 owned by the insured person 40 while the vehicle ID added to the battery information transmitted from the vehicle 10 is associated with the driver ID of the insured person 40, a lot number and a type of the battery 130 mounted on the vehicle, and an insurance premium amount, a type, a class, a discount service, and the like of insurance currently applied to the vehicle.

The insured person information also includes information such as a password for permitting the information terminal 401 of the insured person 40 to access the server device 220. In a case in which the information to be presented to the specific insured person 40 is transmitted from the information terminal 321 and the like of the insurance company 30, the information is added to the insured person information.

The insured person information management unit 222 adds information addressed to the specific insured person 40 received from the information terminal 321 of the insurance company 30 to a piece of the insured person information matching the driving ID added to the received information among a plurality of pieces of the insured person information stored in the insured person information storage unit 229a, and stores the information.

The risk calculation unit 223, the ignition risk determination unit 224, and the correlation storage unit 229c have the same configuration and functions as those of the risk calculation unit 123, the ignition risk determination unit 124, and the correlation storage unit 129c according to the first embodiment described above, respectively.

The handling determination unit 227 acquires the battery information matching the driver ID and the vehicle ID as determination targets from a plurality of pieces of the battery information stored in the battery information storage unit 229b. The handling determination unit 227 extracts information concerning a handling state of the battery 130 from the acquired battery information, and determines appropriateness of handling of the battery 130 by the insured person 40.

As the information concerning the handling state of the battery 130, the handling determination unit 227 extracts a history of variation of the value of the SOC, a history of temperature variation of the battery 130, a use frequency of sudden acceleration and sudden braking, and the like are extracted.

The battery 130 such as a lithium ion battery is preferably used with the SOC of about 50% as a median. For example, in a case in which the battery 130 is left for a long time in a state in which the SOC is high, deterioration of the battery 130 may progress. It is also undesirable that the battery 130 is left in a high-temperature state equal to or higher than a given temperature for a long time. Additionally, the battery 130 may be damaged by repeated charge and discharge or sudden acceleration when the battery 130 is in a low-temperature state equal to or lower than a given temperature.

The handling determination unit 227 determines whether handling of the battery 130 by the insured person 40 is appropriate, or whether the battery 130 is easily damaged by the handling, based on various numerical values extracted from the battery information.

The insurance premium determination unit 225 refers to an insurance premium amount table stored in the insurance premium amount storage unit 229d, and determines the insurance premium set for the vehicle 10 based on a determination result of the ignition risk determination unit 224 and a determination result of the handling determination unit 227 while taking into account a class and the like of the insured person 40 who owns the vehicle 10. The class of the insured person 40 may be set based on an accident history, an offense history, and the like of the insured person 40 as usual.

The insurance premium amount storage unit 229d stores a plurality of insurance premium amount tables corresponding to a vehicle type, a year, and the like. In each of the insurance premium amount tables, the insurance premium amount corresponding to the class of the insured person 40, the ignition risk of the vehicle 10, and the handling state of the battery 130 is set. The insurance premium amount storage unit 229d may also store information concerning a discount system for the insurance premium corresponding to the handling state of the battery 130.

The insurance premium determination unit 225 determines whether each of the insured persons 40 can be an application target of the discount system stored in the insurance premium amount storage unit 229d, and may apply the discount system to the insured person 40 appropriately handling the battery 130.

The insurance premium determination unit 225 also compares the finally determined insurance premium with the pre-updated insurance premium. In a case in which the currently determined insurance premium is increased beyond a given rate as compared with the pre-updated insurance premium, the insurance premium determination unit 225 causes information concerning this fact to be included in the information on the insurance premium to be transmitted to the insurance company 30.

The transmission unit 226 adds the vehicle ID to the information on the insurance premium determined by the insurance premium determination unit 125, and transmits the information to the information terminal 321 of the insurance company 30. In a case in which the insurance premium determination unit 225 adds, to the information on the insurance premium, the information indicating that the currently determined insurance premium is increased beyond the given rate as compared with the previous insurance premium, the transmission unit 226 additionally transmits the information on the increase in the insurance premium.

In a case in which the information on the insurance premium of the given insured person 40 received from the server device 220 includes the information on the increase in the insurance premium, the information terminal 321 of the insurance company 30 generates information on a current state of the battery 130 mounted on the vehicle 10 of the insured person 40 as information to be presented to the insured person 40, and transmits the information to the server device 220.

In a case in which the current insurance premium is increased beyond the given rate as compared with the previous insurance premium, it can be considered that handling of the battery 130 by the insured person 40 is not appropriate, and an undesirable state has been caused such that deterioration of the battery 130 progresses more than usual. By presenting the current state of the battery 130 to the insured person 40, the insured person 40 can notice that deterioration of the battery 130 progresses, for example.

The information terminal 321 may also transmit, to the server device 220, a guideline and the like describing a method for appropriately handling the battery 130 as the information to be presented to the insured person 40. Due to this, the insured person 40 can receive coaching for properly handling the battery 130, and the insured person 40 is enabled to appropriately handle the battery 130.

The information for the insured person 40 transmitted from the information terminal 321 to the server device 220 is received by the reception unit 221, added to the insured person information of the insured person 40 by the insured person information management unit 222, and stored in the insured person information storage unit 229a.

The information presentation unit 228 receives access to the server device 220 from the information terminal 401 of the insured person 40. The insured person 40 can access the server device 220 from the information terminal 401 owned by himself/herself by inputting a driver ID and a password, for example. The information presentation unit 228 refers to the insured person information storage unit 229a, and determines whether there is insured person information matching the driver ID and the password input via the information terminal 401 of the insured person 40.

In a case in which there is insured person information matching the input driver ID and password, the information presentation unit 228 permits the insured person 40 to access the server device 220. In a case in which the insured person information matching the input driver ID and password includes the information to be presented to the insured person 40, the information presentation unit 228 causes the information terminal 401 of the insured person 40 to display the information.

Due to this, the insured person 40 can check the information from the insurance company 30 via the server device 220.

Example of Insurance Premium Determination Processing Performed by Server Device

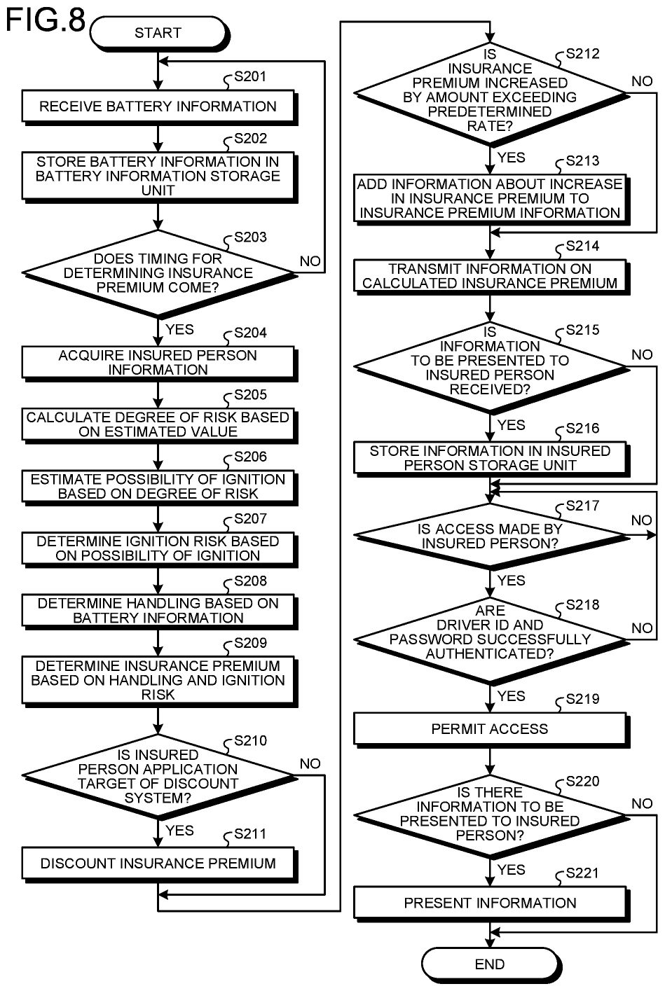

FIG. 8 is a flowchart illustrating an example of a procedure of insurance premium determination processing performed by the server device 220 according to the second embodiment. In starting the processing illustrated in FIG. 8, it is assumed that the server device 220 has already acquired basic information such as a password, a vehicle type, a year, and an insurance premium amount, a type, a class, a discount service, and the like of insurance currently applied to the vehicle among the pieces of insured person information for the insured person 40 as a customer of the insurance company 30, and has already stored the acquired insured person information in the insured person information storage unit 229a.

As illustrated in FIG. 8, the reception unit 221 of the server device 220 receives the battery information generated by the BMU 101 from the vehicle control system 110 of the specific vehicle 10 (Step S201), and stores the received battery information in the battery information storage unit 229b (Step S202). Until a timing of determining the insurance premium (Step S203), the processing at Steps S201 and S202 is repeated.

When the timing of determining the insurance premium comes (Yes at Step S203), the insured person information management unit 222 acquires, from the insured person information storage unit 229a, the insured person information concerning the insured person 40 of the vehicle 10 for which the insurance premium is determined (Step S204).

The risk calculation unit 223 calculates the degree of risk based on the estimated value of the lithium precipitation amount and the estimated value of the minute short-circuiting amount for the vehicle 10 for which the insurance premium is determined (Step S205). The ignition risk determination unit 224 applies the calculated degree of risk to the correlation with the possibility of ignition to estimate the possibility of ignition (Step S206), and determines the ignition risk of the vehicle 10 based on the estimated possibility of ignition (Step S207).

The handling determination unit 227 acquires, from the battery information storage unit 129b, the battery information on the vehicle 10 for which the insurance premium is determined, and determines appropriateness of handling of the battery 130 by the insured person 40 of the vehicle 10 for which the insurance premium is determined based on information such as a history of variation of the value of the SOC, a history of temperature variation of the battery 130, a use frequency of sudden acceleration and sudden braking, and the like included in the acquired battery information (Step S208).

The insurance premium determination unit 225 determines the insurance premium to be set for the vehicle 10 of interest based on a determination result of the handling determination unit 227 and a determination result of the ignition risk determination unit 224 (Step S209).

The insurance premium determination unit 225 also determines whether there is a discount system that can be applied to the vehicle 10 of interest among various discount systems stored in the insurance premium amount storage unit 229d based on the determination result of the handling determination unit 227 (Step S210).

If the insured person 40 is appropriately handling the battery 130, and there is an applicable discount system due to a good determination result of the handling determination unit 227 and the like (Yes at Step S210), the insurance premium determination unit 225 discounts the determined insurance premium by applying the discount system (Step S211).

If there is no applicable discount system (No at Step S210), the insurance premium determination unit 225 advances the process to subsequent Step S212 without a discount.

The insurance premium determination unit 225 determines whether the currently determined insurance premium is increased beyond the given rate as compared with the pre-updated insurance premium (Step S212). If the current insurance premium is increased beyond the given rate as compared with the pre-updated insurance premium (Yes at Step S212), the insurance premium determination unit 225 generates information on the insurance premium to which information concerning the increase in the insurance premium is added (Step S213).

If the current insurance premium is not increased beyond the given rate as compared with the pre-updated insurance premium (No at Step S212), the insurance premium determination unit 225 generates the information on the insurance premium without adding additional information thereto.

The transmission unit 226 transmits, to the information terminal 321 of the insurance company 30, the information concerning the insurance premium generated by the insurance premium determination unit 225 (Step S214).

The reception unit 221 waits for transmission, from the information terminal 321 of the insurance company 30, of the information to be presented to the insured person 40 whose current insurance premium is increased beyond the given rate as compared with the pre-updated insurance premium (Step S215).

If the reception unit 221 receives the information to be presented to the insured person 40 from the information terminal 321 (Yes at Step S215), the insured person information management unit 222 adds the information to a corresponding piece of the insured person information to be stored in the insured person information storage unit 229a (Step S216).

The information presentation unit 228 waits for access to the server device 220 from the information terminal 401 of the insured person 40 (Step S217). If the driver ID and the password are input via the information terminal 401 and access is made to the server device 220 (Yes at Step S217), the information presentation unit 228 refers to the insured person information storage unit 229a, to verify the input driver ID and password (Step S218).

If the input driver ID and password are not adapted (No at Step S218), the information presentation unit 228 does not permit the information terminal 401 to access the server device 220, and continuously waits for access from the information terminal 401 (Step S217).

If the input driver ID and password are successfully authenticated (Yes at Step S218), the information presentation unit 228 permits the information terminal 401 to access the server device 220 (Step S219).

The information presentation unit 228 determines whether there is information to be presented to the insured person 40 having the information terminal 401 to which access permission is given (Step S220). If there is information to be presented (Yes at Step S220), the information presentation unit 228 causes the information terminal 401 to display the information (Step S221).

If there is no information to be presented (No at Step S220), the information presentation unit 228 ends the processing without causing the information terminal 401 to display the information.

As described above, the insurance premium determination processing performed by the server device 220 according to the second embodiment ends.

Overview

A vehicle fire caused by a battery in electric motor vehicles includes a fire the responsibility for which is not appropriately taken by the insured person, such as a fire caused by a manufacturing defect, in addition to a fire caused by the insured person such as a case in which the battery is inappropriately used as described above. However, in the current insurance system, the premium is not determined in accordance with how the battery is used by the insured person and the state of the battery at the time of purchase. Thus, the insured person who appropriately uses the battery may feel a sense of unfairness in some cases.

The server device 220 according to the second embodiment determines the insurance premium based on the information concerning handling of the battery 130 by the insured person 40. Due to this, the insurance premium can be appropriately set in accordance with the state of the battery 130. Additionally, an advantage is given such that a low insurance premium is applied to the vehicle 10 of the insured person 40 who appropriately uses the battery 130, and a sense of unfairness of the insured person can be alleviated.

Regarding the server device 220 according to the second embodiment, the information concerning handling of the battery 130 includes a history of at least one of the SOC of the battery 130 and the temperature of the battery 130. Due to this, it is possible to accurately determine how the battery 130 is handled by the insured person 40.

The server device 220 according to the second embodiment determines whether to apply the discount system for the insurance premium based on the information concerning handling of the battery 130. Due to this, the insurance premium of the insured person 40 who appropriately handles the battery 130 is discounted, and a sense of unfairness of the insured person is alleviated.

In a case in which the insurance premium determined by using the information concerning handling of the battery 130 is increased beyond the given rate as compared with the pre-updated insurance premium, the server device 220 according to the second embodiment presents the information concerning the state of the battery 130 to the insured person 40. Due to this, the insured person 40 can recognize that handling of the battery 130 by himself/herself is inappropriate, and the insured person 40 can be encouraged to improve handling. Accordingly, deterioration of the battery 130 can be suppressed, and a risk of a vehicle fire caused by the battery 130 can be reduced.

The server device 220 according to the second embodiment presents the information concerning the method for handling the battery 130 to the insured person 40. Due to this, the insured person 40 can find out an appropriate method for handling the battery 130, deterioration of the battery 130 can be suppressed, and a risk of a vehicle fire caused by the battery 130 can be reduced.

In the second embodiment described above, it is assumed that the insurance premium determination unit 225 calculates a rate of increase of the current insurance premium, and the information presentation unit 228 presents the information to the insured person 40 whose insurance premium is increased beyond the given rate. Alternatively, for example, it may be assumed that the handling determination unit 227 regularly or irregularly extracts insured persons who inappropriately handle the battery, and the information may be presented to the insured persons.

In the second embodiment described above, it is assumed that the insured person 40 accesses the server device 220 by using the information terminal 401, and checks the information concerning the state of the battery 130 and the like addressed to himself/herself. However, a method for presenting the information to the specific insured person 40 is not limited thereto.

For example, in a case in which the server device has email address information and the like of the insured persons 40 in the insured person information and the like, and acquires the information to be presented to a specific one of the insured persons 40 from the information terminal 321 of the insurance company 30, the server device may transmit the information to the email address of the specific insured person 40. In this case, it is assumed that the insurance company 30 obtains consent of the insured person 40 in advance to use such an email address of the insured person 40.

In the second embodiment described above, it is assumed that the information terminal 321 of the insurance company 30 generates the information to be presented to the insured person 40, and transmits the information to the server device 220. Alternatively, the server device may generate the information for the insured person 40.

In this case, the server device may transmit the generated information to the information terminal of the insurance company 30, may present the information to the information terminal 401 of the insured person 40 that has accessed the server device after obtaining consent of the insurance company 30, or may transmit the information to the information terminal 401 of the insured person 40.

First Modification

Next, the following describes the server device according to a first modification of the second embodiment. The server device according to the first modification is different from that in the second embodiment described above in that the server device according to the first modification determines the insurance premium to be set for the insured person.

The insured person information management unit as an identification information management unit included in the server device as an information processing device according to the first modification associates the driver ID as identification information on the insured person with the information concerning handling of the battery by the insured person to be managed.

The insurance premium determination unit included in the server device according to the first modification determines the insurance premium to be set for the insured person based on the information concerning handling of the battery by the insured person. The insured person may be a corporation such as an enterprise, an organization, an association, or the like.

Insurance as an object of the server device according to the first modification may be driver insurance applied to a driver himself/herself, one-day automobile insurance, and the like in a case in which the driver rents a vehicle of a friend or an acquaintance, in a case in which the driver drives a vehicle of a ride-sharing service or a car-sharing service, and the like. In this case, the vehicle to be covered by the insurance may be, for example, a vehicle rented from a friend or an acquaintance, an allocated vehicle that is allocated by a ride-sharing service, a car-sharing service, or the like, a vehicle used for commodity distribution such as delivery work, a leased vehicle, and the like. In a case in which the vehicle for which the insurance is contracted is a leased vehicle, by providing information for a lease dealer, for example, the lease dealer can variously use the provided information by reflecting an amount of the insurance premium in a lease price.

The server device according to the first modification associates the driver ID with which the insured person can be uniquely identified with the information concerning handling of the battery to be managed. The insurance premium determined by the server device is set for the insured person. Due to this, the insurance premium can be determined for driver insurance, one-day automobile insurance, and the like, and convenience for the insured person is improved.

Second Modification

Next, the following describes the server device according to a second modification of the second embodiment. An addition system of the insurance premium corresponding to the handling state of the battery is applied to the server device according to the second modification.

The insurance premium amount storage unit according to the second modification stores various kinds of information similar to those in the insurance premium amount storage unit 229d according to the second embodiment described above. The insurance premium amount storage unit according to the second modification may also store information concerning the addition system of the insurance premium corresponding to the handling state of the battery.

The insurance premium determination unit according to the second modification may determine, for each of the insured persons, whether the insured person can be an application target of the addition system stored in the insurance premium amount storage unit, and may apply the addition system to the insured person who roughly handles the battery.

Typically, in a case of not introducing the server device, the insurance premium determining method, and the system according to the present disclosure, the insurance premium is not set in accordance with the state of the battery, so that vehicle insurance is indiscriminately set even for a person who uses a vehicle in a battery-friendly manner, and such an insured person feels a sense of unfairness.

With the server device according to the second modification, the state of (method of using) the battery is reflected in the insurance premium, and the insurance premium may be set to be high for some insured persons. That is, the insurance premium becomes high for the insured person who roughly handles the battery and uses a vehicle in a way that easily causes the battery to be in a state in which the ignition risk is high, and the insurance premium becomes low for the insured person who does not roughly handle the battery and uses a vehicle in a way that hardly causes the battery to be in a state in which the ignition risk is high.

In this way, the insurance premium of the insured person is set in accordance with handling of the battery, so that a sense of fairness of the insured person about the insurance premium is heightened. Furthermore, regarding the insured person who roughly handles the vehicle in a way that easily damages the battery, motivation for lowering the insurance premium by appropriately handling the vehicle is enhanced. Accordingly, such an insured person improves the method for using the battery to be battery-friendly, so that a service life of the battery can be prolonged, and as a result, convenience for the insured person, the lease dealer, or the like can be enhanced.

The functional configurations of the server device and the functional configurations of the BMU 101 according to the first and the second embodiments described above and the first and the second modifications thereof are merely examples. The server device and the BMU 101 do not necessarily include all of the functional configurations described above, or may include another functional configuration in addition to the functional configurations described above. Alternatively, the ECU or the BMU may include part or all of the functional configurations of the server device, or the server device may include part or all of the functional configurations of the BMU. That is, the information processing device according to the present disclosure is not limited to the server device according to the first and the second embodiments described above and the first and the second modification thereof, but may be the ECU, the BMU, or the like.

The embodiments of the present disclosure have been described above. These embodiments are merely examples, and do not intend to limit the scope of the invention. These embodiments can be implemented in various other forms, and can be variously omitted, replaced, and modified without departing from the gist of the invention. These embodiments and the modifications thereof are encompassed by the scope and the gist of the present invention, and also encompassed by the invention described in CLAIMS and an equivalent thereof.

What is claimed is:

1. An information processing device comprising:
one or more hardware processors configured to function as:
a risk calculation unit configured to calculate a degree of risk indicating a risk of ignition of a battery as an index based on information concerning an ignition factor of the battery mounted on a vehicle; and
an insurance premium determination unit configured to determine an insurance premium in accordance with the degree of risk.

2. The information processing device according to claim 1, wherein
the battery is a lithium ion battery,
the information includes a lithium precipitation amount in the battery, and
the lithium precipitation amount is estimated from voltage variation and current variation in the battery during charge and discharge.

3. The information processing device according to claim 2, wherein the lithium precipitation amount is estimated by using voltage variation and current variation at a time when a charging state that is a ratio of a residual capacity to a full charge capacity of the battery, falls within a given range, a charging current is constant, and a discharging current is constant.

4. The information processing device according to claim 1, wherein
the information includes a minute short-circuiting amount in the battery, and
the minute short-circuiting amount is estimated from voltage variation in the battery at a time when charge and discharge are not performed.

5. The information processing device according to claim 4, wherein
the minute short-circuiting amount is estimated by using voltage variation at a time when a charging state that is a ratio of a residual capacity to a full charge capacity of the battery, falls within a given range, and a temperature of the battery is equal to or higher than a given temperature.

6. The information processing device according to claim 1, wherein the one or more hardware processors are configured to further function as:
an ignition risk determination unit configured to determine an ignition risk of the battery based on a correlation between the degree of risk and a possibility that the battery is ignited, wherein
the insurance premium determination unit determines the insurance premium based on a determination result of the ignition risk.

7. The information processing device according to claim 1, wherein
the insurance premium determination unit determines the insurance premium based on information concerning handling of the battery by an insured person who drives the vehicle.

8. The information processing device according to claim 7, wherein the information concerning handling of the battery includes a history of at least one of a charging state that is a ratio of a residual capacity to a full charge capacity of the battery, and a temperature of the battery.

9. The information processing device according to claim 7, wherein the insurance premium determination unit determines whether to apply a discount system for the insurance premium based on the information concerning handling of the battery.

10. The information processing device according to claim 7, wherein the one or more hardware processors are configured to further function as:
an information presentation unit configured to present information concerning a state of the battery to the insured person in a case in which an insurance premium determined by using the information concerning handling of the battery is increased beyond a given rate as compared with a pre-updated insurance premium.

11. The information processing device according to claim 10, wherein the information presentation unit presents information concerning a method for handling the battery to the insured person as a presentation target.

12. The information processing device according to claim 7, wherein the one or more hardware processors are configured to further function as:
an identification information management unit configured to associate identification information with which the insured person is uniquely identifiable with the information concerning handling of the battery to be managed, wherein
the insurance premium is set for the insured person.

13. The information processing device according to claim 1, wherein the insurance premium is set for the vehicle.

14. The information processing device according to claim 1, wherein the vehicle is a vehicle covered by insurance contracted by an insured person.

15. The information processing device according to claim 1, wherein the information processing device is a server device.

16. An insurance premium determining method implemented by a computer, the method comprising:
calculating a degree of risk indicating a risk of ignition of a battery as an index based on information concerning an ignition factor of the battery mounted on a vehicle; and
determining an insurance premium in accordance with the degree of risk.

17. A system comprising:
an information generation unit configured to generate information concerning an ignition factor of a battery based on voltage variation and current variation in the battery mounted on a vehicle;
a risk calculation unit configured to calculate a degree of risk indicating a risk of ignition of the battery as an index based on the information; and
an insurance premium determination unit configured to determine an insurance premium in accordance with the degree of risk.
